(19) United States
(12) Patent Application Publication
(10) Pub. No.: US 2014/0325418 A1
(43) Pub. Date: Oct. 30, 2014

(54) AUTOMATICALLY MANIPULATING VISUALIZED DATA BASED ON INTERACTIVITY

(71) Applicant: MICROSOFT CORPORATION, Redmond, WA (US)

(72) Inventors: Steve Tullis, Redmond, WA (US); Uhl Albert, Kirkland, WA (US)

(73) Assignee: Microsoft Corporation, Redmond, WA (US)

(21) Appl. No.: 13/874,216

(22) Filed: Apr. 30, 2013

(51) Int. Cl. G06F 3/01

(52) U.S. Cl. CPC G06F 3/017
USPC 715/771

(57) ABSTRACT

A data visualization application automatically manipulates visualized data based on interactivity. Detected gestures such as touch actions, visual and audio commands, and eye-tracking are matched to an associated operation to be applied to data of the visualization. The operations include expansion, reduction, merge, split, zoom in, zoom out, style change, and similar ones. The operation is executed on the data of the visualization resulting in changes to the data. The visualization is updated to display the changes to the data.

### BACKGROUND

People interact with computer applications through user interfaces. While audio, tactile, and similar forms of user interfaces are available, visual user interfaces through a display device are the most common form of user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications render visual effects through a display and enable users to provide input associated with the applications' operations.

Modern platforms present data in textual form which is seldom combined with visual representations. In contemporary solutions data is usually presented to users in tables. Users select or define parameters for visualization of the presented data manually. Although, some portions of the data visualization are automated, such as ready-made charts, common data visualizations start with a user interaction. Subsequent data visualizations involve multiple user interactions with the data. Expansion of data analysis in the work place and personal lives necessitate elimination of manual user interactions while generating and updating data visualization for efficient utilization of data analysis.

Manipulation of visualized data is a source of additional difficulties associated with data visualization. In contemporary solutions, manual steps are necessary in selecting visualization parameters (scale, axes, increments, style, etc.), range of data, and others. The manual aspects make data visualization counter-productive and counter-intuitive within the touch and/or gesture based intuitive and automated interaction environment of modern and future computing technologies.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to automatically manipulating visualized data based on interactivity. According to some embodiments, a data visualization application may display a visualization of data such as a graph presenting data analysis results. The application may detect a gesture interacting with the visualization and determine an operation associated with the gesture. The operation may include an expansion, a reduction, a merge, a split, a zoom in, a zoom out, a style change, or similar ones to be applied on the visualization. The operation may be executed on the data of the visualization and the data may be changed in response to instructions of the operation. Next, the application may update the visualization to display a change associated with the executed operation on the data. The update may apply the change to the visualization. Alternatively, the application may display a new visualization if the change provides for a new visualization.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example concept diagram of automatically manipulating visualized data based on interactivity according to some embodiments;

FIG. 2 illustrates an example of a reduction operation to manipulate visualized data based on interactivity according to embodiments;

FIG. 3 illustrates an example of an expansion operation to manipulate visualized data based on interactivity according to embodiments;

FIG. 4 illustrates an example of a zoom in operation to manipulate visualized data based on interactivity according to embodiments;

FIG. 5 illustrates an example of a merge operation to manipulate visualized data based on interactivity according to embodiments;

FIG. 6 illustrates an example of a style change operation to manipulate visualized data based on interactivity according to embodiments;

FIG. 7 is a networked environment, where a system according to embodiments may be implemented;

FIG. 8 is a block diagram of an example computing operating environment, where embodiments may be implemented; and

FIG. 9 illustrates a logic flow diagram for a process automatically manipulating visualized data based on interactivity according to embodiments.

### DETAILED DESCRIPTION

As briefly described above, visualized data may be automatically manipulated based on interactivity. A data visualization application may determine an operation associated with a gesture detected on a displayed visualization of data. The visualization may be updated to display a change on the data in response to execution of the operation on the data of the visualization.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for automatically manipulating visualized data based on interactivity. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

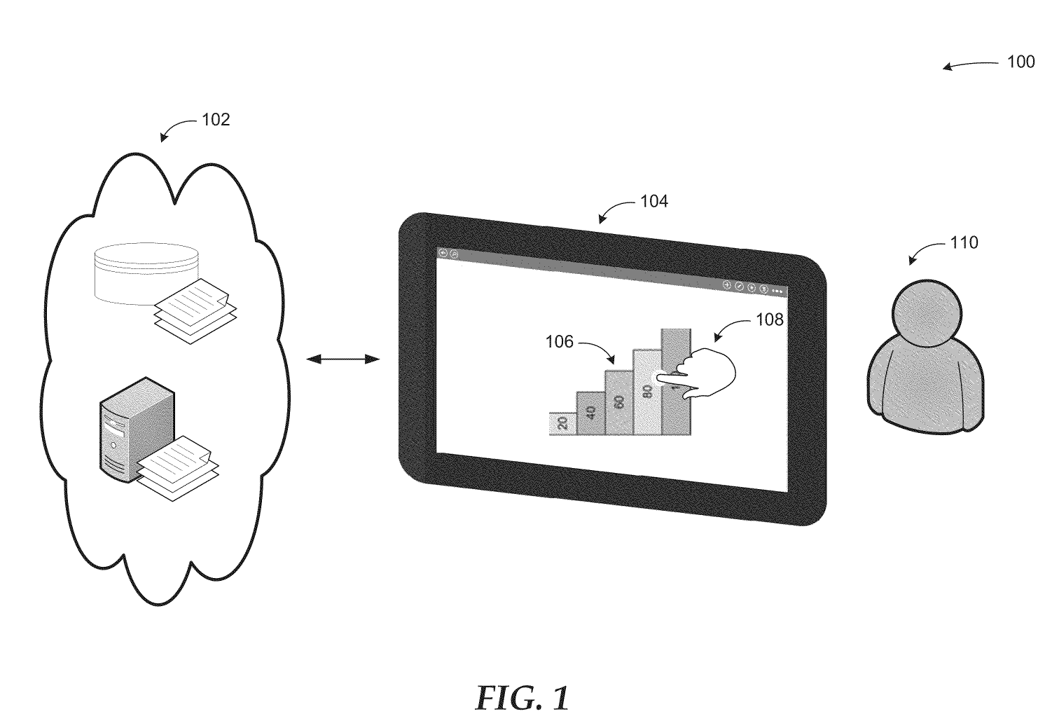

FIG. 1 illustrates an example concept diagram of automatically manipulating visualized data based on interactivity according to some embodiments. The components and environments shown in diagram 100 are for illustration purposes. Embodiments may be implemented in various local, networked, cloud-based and similar computing environments employing a variety of computing devices and systems, hardware and software.

A device 104 may display a visualization 106 to a user 110. The visualization 106 is displayed by a data visualization application presenting data and associated visualizations. The visualization 106 may be a graph, a chart, a three-dimensional (3D) representation, a graphic, an image, a video, and comparable ones. The visualization 106 may be a presentation of underlying data. The data may be manipulated in response to a user interaction with the visualization. An example may include a user providing a gesture 108 to zoom into a portion of the visualization. The data of the visualization 106 may be scaled to match a range determined from the gesture 108. The change in the data may be reflected in the visualization 106 through an update to the visualization 106. In addition, the device 104 may recognize the gesture 108 through its hardware capabilities which may include a camera, a microphone, a touch-enabled screen, a keyboard, a mouse, and comparable ones.

The device 104 may communicate with external resources such as a cloud-hosted platform 102 to retrieve or update the data of the visualization 106. The cloud-hosted platform 102 may include remote resources including data stores and content servers. The data visualization application may auto-generate the visualization from the retrieved data based on context information associated with a user and/or the data.

Embodiments are not limited to implementation in a device 104 such as a tablet. The data visualization application according to embodiments may be a local application executed in any device capable of displaying the application. Alternatively, the data visualization application may be a hosted application such as a web service which may execute in a server while displaying application content through a client user interface such as a web browser. In addition to a touch-enabled device 104, interactions with the visualization 106 may be accomplished through other input mechanisms such as optical gesture capture, a gyroscopic input device, a mouse, a keyboard, an eye-tracking input, and comparable software and/or hardware based technologies.

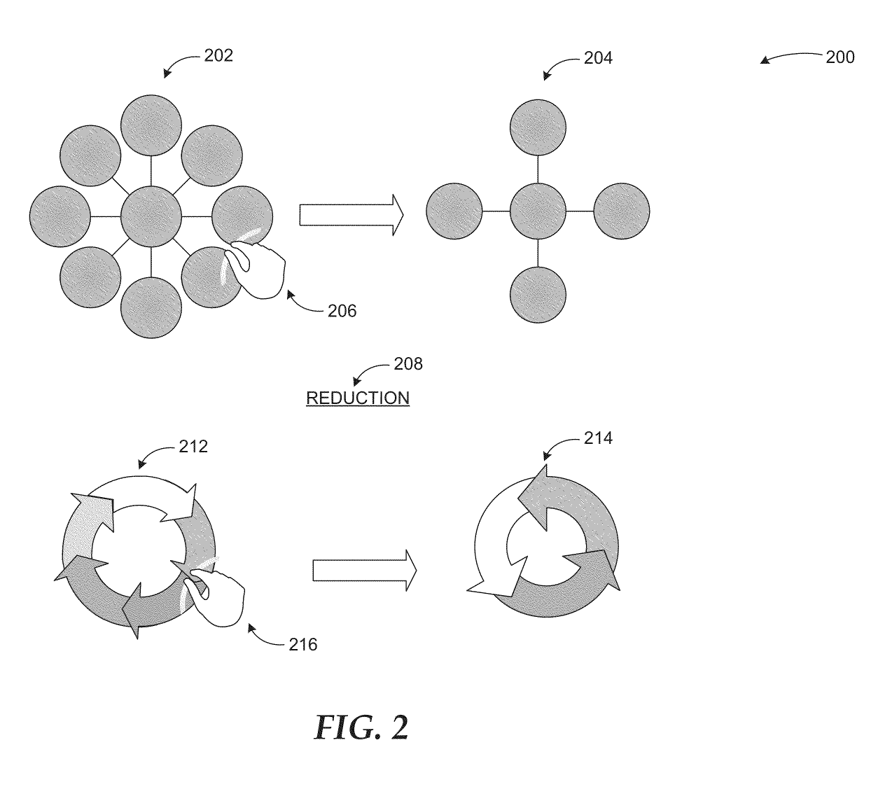

FIG. 2 illustrates an example of a reduction operation to manipulate visualized data based on interactivity according to embodiments. Diagram 200 displays examples of scope reduction of visualized data in response to gestures 206 and 216 on corresponding visualizations 202 and 212.

The data visualization application may detect a gesture 206 on visualization 202. The application may interpret the gesture 206 as a pinch action. The pinch action may be matched to a reduction operation 208. The application may apply the reduction operation 208 to the data of the visualization 202 to reduce the scope of the displayed data. In an example scenario, the application may reduce the number of data elements in proportion to the length of the pinch action. The application may update the data to mark the reduction in number of displayed data elements. Subsequently, the application may update the visualization 202 to reflect the reduction in displayed elements by displaying the updated visualization 204. The application may maintain format, style, and other characteristics of visualization 202 during the reduction operation 208. Alternatively, the application may display another visualization style in response to context information associated with the updated data and the user.

In a similar example, a length of the gesture 216 may be used to reduce the number of displayed elements in a visualization 212 proportionally. The application may determine the length of the gesture 216 such as a pinch action and calculate a ratio based on the end length of the pinch action and the start length of the pinch action. The calculated ratio may be applied to the number of displayed data elements of the visualization. The application may update the data of the visualization 212 to reflect a reduction in number of displayed data elements. The visualization may be updated to the updated visualization 214 to reflect the reduction operation 208 on the data of the visualization 212.

The gestures 206 and 216 are non-limiting examples. Other gestures such as swipes, eye movements, voice commands, and comparable ones may be used to execute a reduction operation 208 on the data of a visualization. The application is also not limited to utilizing a length of the gesture to determine a proportional reduction in displayed data elements. In an alternative scenario, the application may use a speed of the gesture to determine the proportional reduction in the number of displayed data elements. A high speed gesture (compared to a predetermined speed value) may be interpreted to reduce additional number of displayed data elements while a low speed gesture may be interpreted to reduce fewer number of displayed data elements. Alternatively, a low speed gesture may be interpreted to reduce additional number of displayed data elements while a high speed gesture may be interpreted to reduce fewer number of displayed data elements. The speed may be interpreted based on an average speed calculation of sampled gesture speed within the duration of the gesture.

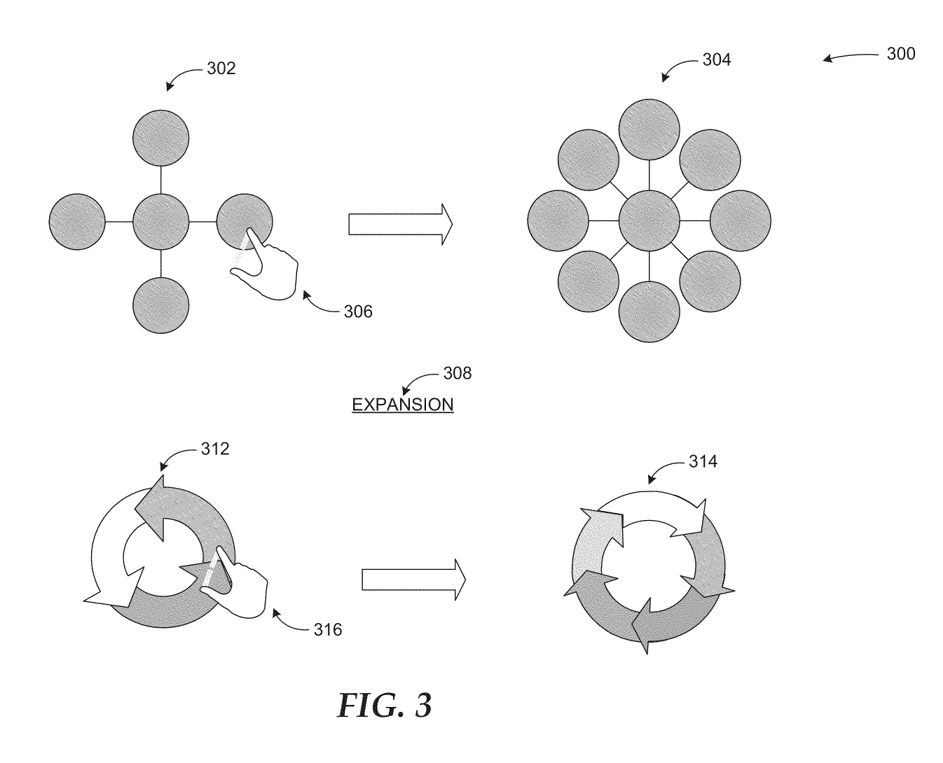

FIG. 3 illustrates an example of an expansion operation to manipulate visualized data based on interactivity according to embodiments. Diagram 300 displays examples of scope expansion in response to gestures 306 and 316 on corresponding visualizations 302 and 312.

The data visualization application may detect a gesture 306 on visualization 302. The application may interpret the gesture 306 as a spread action. The spread action may be matched to an expansion operation 308. The application may apply the expansion operation 308 to the data of the visualization 302 to expand the scope of the displayed data. In an example scenario, the application may expand the number of data elements in proportion to the length of the expansion action. The application may update the data to mark an expansion in number of displayed data elements. Subsequently, the application may update the visualization 302 to reflect the expansion in displayed elements by displaying the updated visualization 304. The application may maintain format, style, and other characteristics of visualization 302 during the expansion operation 308. Alternatively, the application may display another visualization style in response to context information associated with the updated data and the user.

In a similar example, a length of the gesture 316 may be used to expand the number of displayed elements in a visualization 312 proportionally. The application may determine the length of the gesture 316 such as a spread action and calculate a ratio based on the end length of the spread action and the start length of the spread action. The calculated ratio may be applied to the number of displayed data elements in visualization 312. The application may update the data of the visualization 312 to reflect an expansion in the number of displayed data elements. The visualization may be updated to the visualization 314 to reflect the expansion operation 308 on the data of the visualization 312.

The gestures 306 and 316 are non-limiting examples. Other gestures such as swipes, eye movements, voice commands, tap action (i.e.: single or double tap) and comparable ones may be used to execute an expansion operation 308 on the data of a visualization. The application is also not limited to utilizing a length of the gesture to determine a proportional expansion in displayed data elements. In an alternative scenario, the application may use a speed of the gesture to determine the proportional expansion in the number of displayed data elements. A high speed gesture (compared to a predetermined speed value) may be interpreted to expand additional number of displayed data elements while a low speed gesture may be interpreted to expand fewer number of displayed data elements. Alternatively, a low speed gesture may be interpreted to expand additional number of displayed data elements while a high speed gesture may be interpreted to expand fewer number of displayed data elements. The speed may be interpreted based on an average speed calculation of sampled gesture speed within the duration of the gesture.

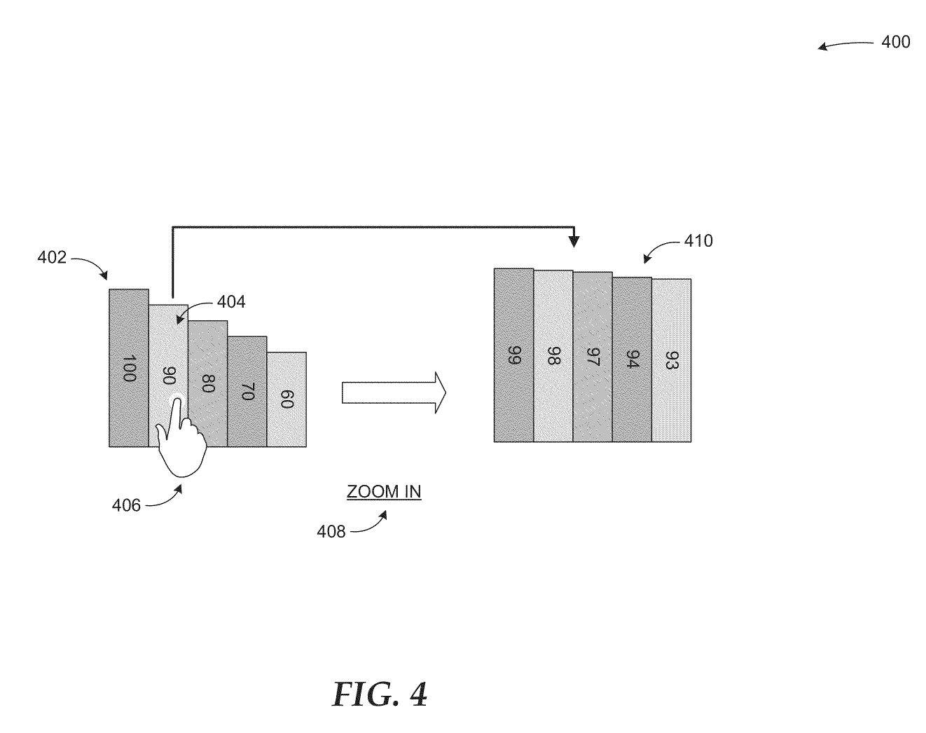

FIG. 4 illustrates an example of a zoom in operation to manipulate visualized data based on interactivity according to embodiments. Diagram 400 displays an example zoom in operation 408 in response to a gesture 406.

The data visualization application may display visualization 402 as a bar chart of a data set. The visualization may present data points based on a system or user setting specifying the increments between the data points. A gesture 406 such as a tap action, including a single tap or a double tap action, may be detected on displayed data element 404. The application may match the tap action to a zoom in operation 408 on the displayed data element 404.

The application may execute the zoom in operation and retrieve a range of data elements within predetermined outer boundaries, provided by user or system settings, centered on the displayed data element 404. The range of data elements may be marked for display in visualization 410. The outer boundaries of the range may be dynamically adjusted to match available data elements in the data as a response to current and subsequent zoom in operations.

The tap action is a non-limiting example of a gesture 406 initiating a zoom in operation 408. Other gesture types may be used to initiate a zoom in operation 408 such as a swipe action, voice command, an eye movement, and comparable ones. Alternatively, another gesture detected outside the visualization may be matched to a zoom out operation to zoom out of the data elements displayed in the visualization. The application may execute the zoom out operation on the data and select a range of data elements including the displayed data elements. Outer boundaries of the range may be determined based on the location of the gesture. The outer boundaries of the range may be centered on a displayed data element that is adjacent to a location of the gesture outside the visualization. Adjacent location may be a location above or below of a displayed data element. Alternatively, adjacent location may be location right or left of a displayed data element. The outer boundaries may be determined based on inclusion of all the displayed data elements in the visualization as a lower limit. The reach of the outer boundaries may be determined by a predetermined system or user setting as a higher limit. The application may next update the visualization to display the range.

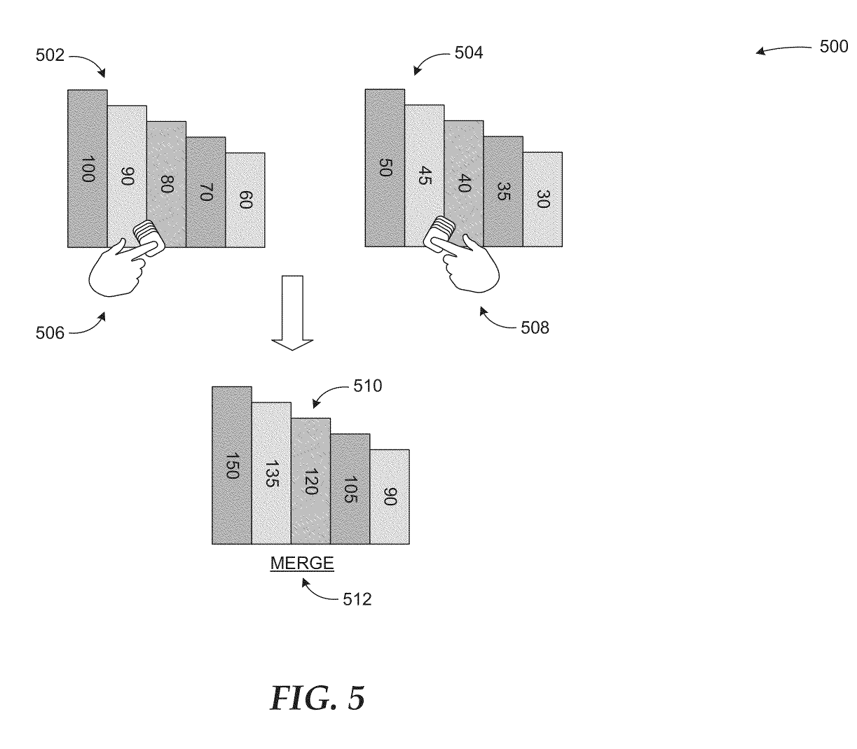

FIG. 5 illustrates an example of a merge operation to manipulate visualized data based on interactivity according to embodiments. Diagram 500 illustrates an example of applying a merge operation to data of two visualizations 502 and 504 to display a merged visualization 510.

The data visualization application may detect multiple gestures to initiate a merge operation 512 on two displayed visualizations 502 and 504. The application may interpret the gestures 506 and 508 to converge. In response to convergence determination of two gestures, a merge operation may be executed on the data of visualizations 502 and 504. The merge operation may be defined by the system or a user. In an example scenario, the merge operation may be matching the data elements of the visualizations 502 and 504 and adding the matched data elements to result in a set of a merged data elements stored in a merged data set that will be displayed in visualization 510. Matching the data elements may be based on attributes of the data elements of the data sets associated with the visualizations 502 and 504.

Alternatively, the data visualization application may prompt for a user input for those data elements of the data sets that are not automatically matched. Additionally, the merge operation may include any equation defined by the system or the user including an addition, a multiplication, a subtraction, a division, a custom equation, and comparable ones. The application may apply the equation to the matched data elements of the data sets to generate the merged data set. A merged visualization 510 of the merged data may be displayed in place of the two visualizations 502 and 504. In an alternate scenario, the merge operation may combine the matched data elements by placing corresponding visualization elements adjacent to each other in the merged visualization instead of applying an equation to the matched data elements. In another alternate scenario, the merge operation may combine the matched data elements in the merged visualization by rendering one set of the matched data elements using a type of visualization such as a bar chart and rendering the other set of the matched data elements using another type of visualization such as a line chart.

The gestures are not limited to a multi-touch action to initiate a merge operation. Other gestures such as a pinch action, tap and hold, drag and drop, and similar ones may be used to merge two or more visualizations and their respective data. Alternatively, the application may execute a split operation on the data in response to detecting a gesture associated with the split operation. The split operation may generate two or more data sets from an underlying data of the visualization. The application may generate visualizations corresponding to the generated data sets in response to the split operation.

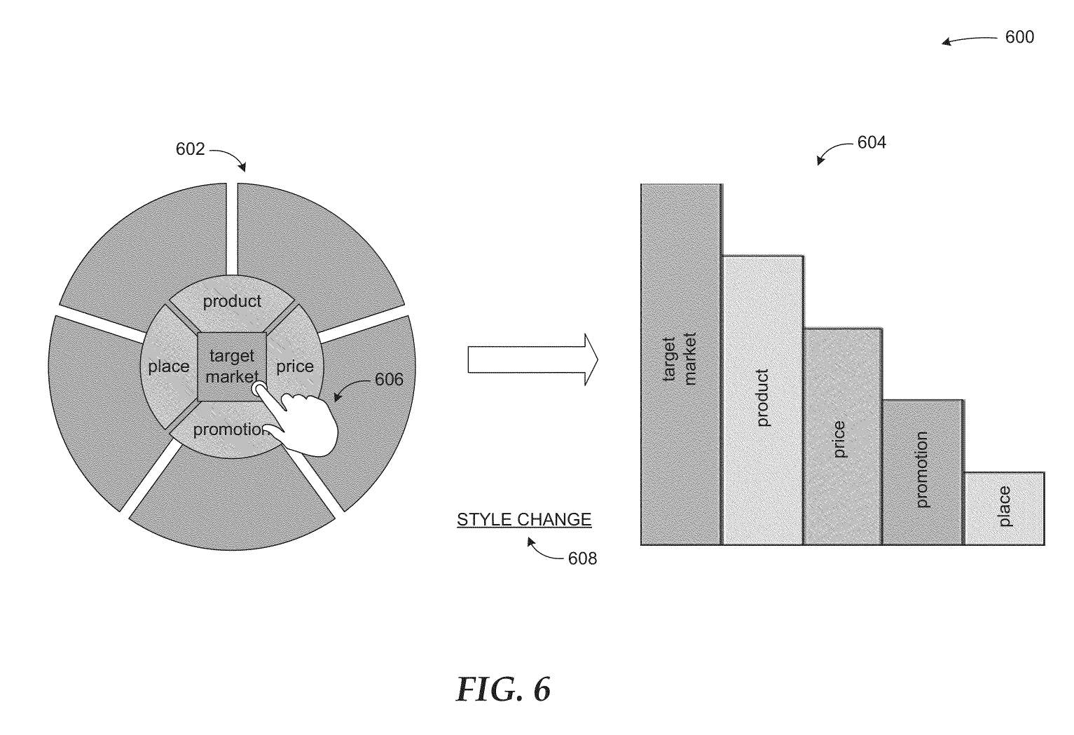

FIG. 6 illustrates an example of a style change operation to manipulate visualized data based on interactivity according to embodiments. Diagram 600 illustrates an example of applying a style change operation 608 to data of visualization 602.

The data visualization application may detect a gesture 606 and match the gesture to a style change operation 608. Predetermined gesture location and/or gesture type combinations may be match criteria to matching the gesture to the style change operation 608. The style change operation may alter stored visualization attributes associated with the data. The application may redraw the visualization based on the alternate visualization attributes of the data. The visualization 604 may be displayed to reflect the execution of the style change operation 608.

Style change operation 608 may alter visualization elements corresponding to data elements. The style change operation 608 may also alter the visualization type. In an example scenario, a bar chart may be converted to a pie chart. Color, shading, depth, shape, highlighting, and comparable attributes of visualization elements or the visualization may be altered by the style change operation 608. The instructions for a style change operation 608 may be user or system configurable.

Embodiments are not limited to automatically updating a visualization based on an operation applied to data of the visualization in response to a gesture. Other embodiments may automatically suggest (auto-suggest) one or more operations to execute on the data of the visualization if there is an inability of the application to determine an operation associated with the gesture. The application may search history of prior operations to select operations related to the detected gesture as auto-suggest options. The auto-suggest feature may present operation options as actionable text descriptions of potential updates to the visualizations. Selection of any of the actionable text descriptions may execute the associated operation and update the visualization in response to the executed operation. Alternatively, the auto-suggest feature may provide actionable graphic representations of potential updates to the visualizations. Selection of any of the actionable graphic representations may execute the associated operation and update the visualization in response to the executed operation. In addition, the style of the visualization may be selected automatically by the application based on context information of the data, visualization, user, and use history.

The example scenarios and schemas in FIG. 2 through 6 are shown with specific components, data types, and configurations. Embodiments are not limited to systems according to these example configurations. Automatically manipulating visualized data based on interactivity may be implemented in configurations employing fewer or additional components in applications and user interfaces. Furthermore, the example schema and components shown in FIG. 2 through 6 and their subcomponents may be implemented in a similar manner with other values using the principles described herein.

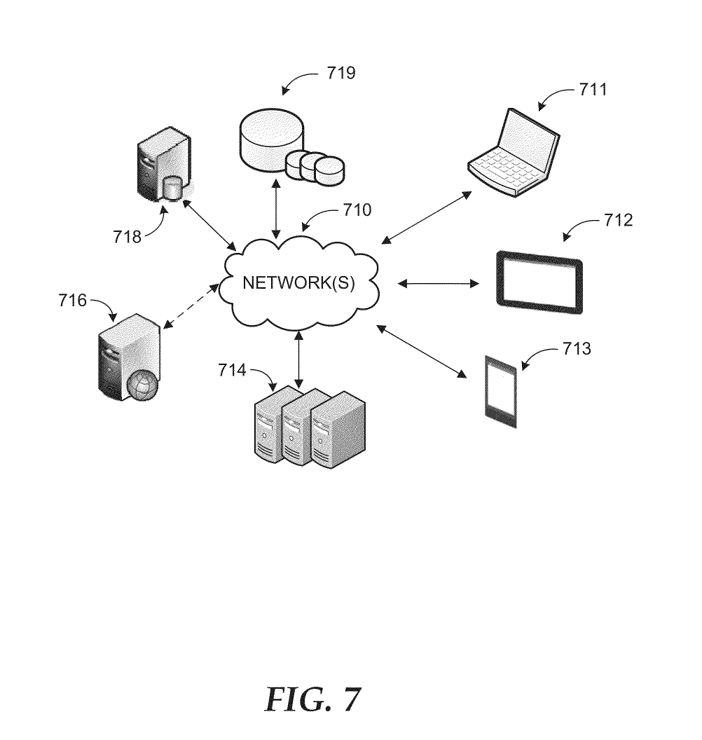

FIG. 7 is a networked environment, where a system according to embodiments may be implemented. Local and remote resources may be provided by one or more servers 714 or a single server (e.g. web server) 716 such as a hosted service. An application may execute on individual computing devices such as a smart phone 713, a tablet device 712, or a laptop computer 711 (‘client devices’) and communicate with a content resource through network(s) 710.

As discussed above, a data visualization application may automatically manipulate visualized data based on interactivity. The application may determine an operation associated with a detected gesture, such a touch action, on a displayed visualization. The operation may be executed on the underlying data. The application may update the visualization using the changes in the data. Client devices 711-713 may enable access to applications executed on remote server(s) (e.g. one of servers 714) as discussed previously. The server(s) may retrieve or store relevant data from/to data store(s) 719 directly or through database server 718.

Network(s) 710 may comprise any topology of servers, clients, Internet service providers, and communication media. A system according to embodiments may have a static or dynamic topology. Network(s) 710 may include secure networks such as an enterprise network, an unsecure network such as a wireless open network, or the Internet. Network(s) 710 may also coordinate communication over other networks such as Public Switched Telephone Network (PSTN) or cellular networks. Furthermore, network(s) 710 may include short range wireless networks such as Bluetooth or similar ones. Network(s) 710 provide communication between the nodes described herein. By way of example, and not limitation, network(s) 710 may include wireless media such as acoustic, RF, infrared and other wireless media.

Many other configurations of computing devices, applications, data resources, and data distribution systems may be employed to automatically manipulate visualized data based on interactivity. Furthermore, the networked environments discussed in FIG. 7 are for illustration purposes only. Embodiments are not limited to the example applications, modules, or processes.

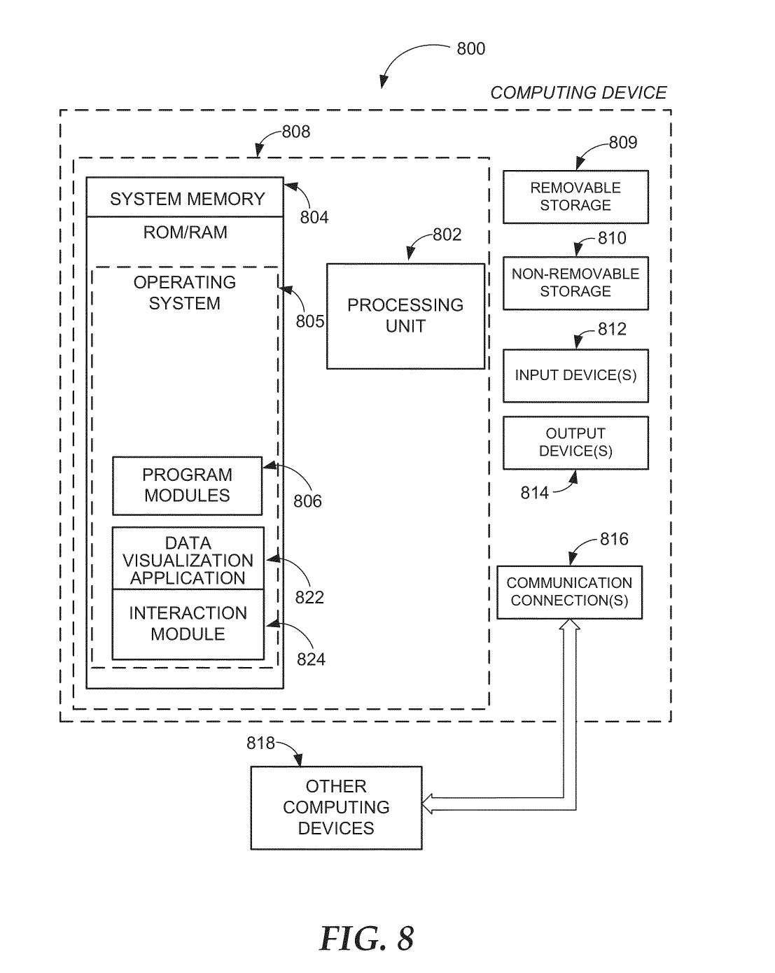

FIG. 8 and the associated discussion are intended to provide a brief, general description of a suitable computing environment in which embodiments may be implemented. With reference to FIG. 8, a block diagram of an example computing operating environment for an application according to embodiments is illustrated, such as computing device 800. In a basic configuration, computing device 800 may include at least one processing unit 802 and system memory 804. Computing device 800 may also include a plurality of processing units that cooperate in executing programs. Depending on the exact configuration and type of computing device, the system memory 804 may be volatile (such as RAM), non-volatile (such as ROM, flash memory, etc.) or some combination of the two. System memory 804 typically includes an operating system 805 suitable for controlling the operation of the platform, such as the WINDOWS® and WINDOWS PHONE® operating systems from MICROSOFT CORPORATION of Redmond, Wash. The system memory 804 may also include one or more software applications such as program modules 806, a data visualization application 822, and an interaction module 824.

A data visualization application 822 may detect a gesture interacting with a displayed visualization. The interaction module 824 may determine an operation, such as a reduction, expansion, merge, split, zoom in, zoom out, and style change operation. The data visualization application 822 may execute the operation on the data of the visualization and update the visualization to display a change associated with the executed operation on the data set. This basic configuration is illustrated in FIG. 8 by those components within dashed line 808.

Computing device 800 may have additional features or functionality. For example, the computing device 800 may also include additional data storage devices (removable and/or non-removable) such as, for example, magnetic disks, optical disks, or tape. Such additional storage is illustrated in FIG. 8 by removable storage 809 and non-removable storage 810. Computer readable storage media may include volatile and nonvolatile, removable and non-removable media implemented in any method or technology for storage of information, such as computer readable instructions, data structures, program modules, or other data. Computer readable storage media is a computer readable memory device. System memory 804, removable storage 809 and non-removable storage 810 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer readable storage media may be part of computing device 800. Computing device 800 may also have input device(s) 812 such as keyboard, mouse, pen, voice input device, touch input device, and comparable input devices. Output device(s) 814 such as a display, speakers, printer, and other types of output devices may also be included. These devices are well known in the art and need not be discussed at length here.

Computing device 800 may also contain communication connections 816 that allow the device to communicate with other devices 818, such as over a wireless network in a distributed computing environment, a satellite link, a cellular link, and comparable mechanisms. Other devices 818 may include computer device(s) that execute communication applications, storage servers, and comparable devices. Communication connection(s) 816 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

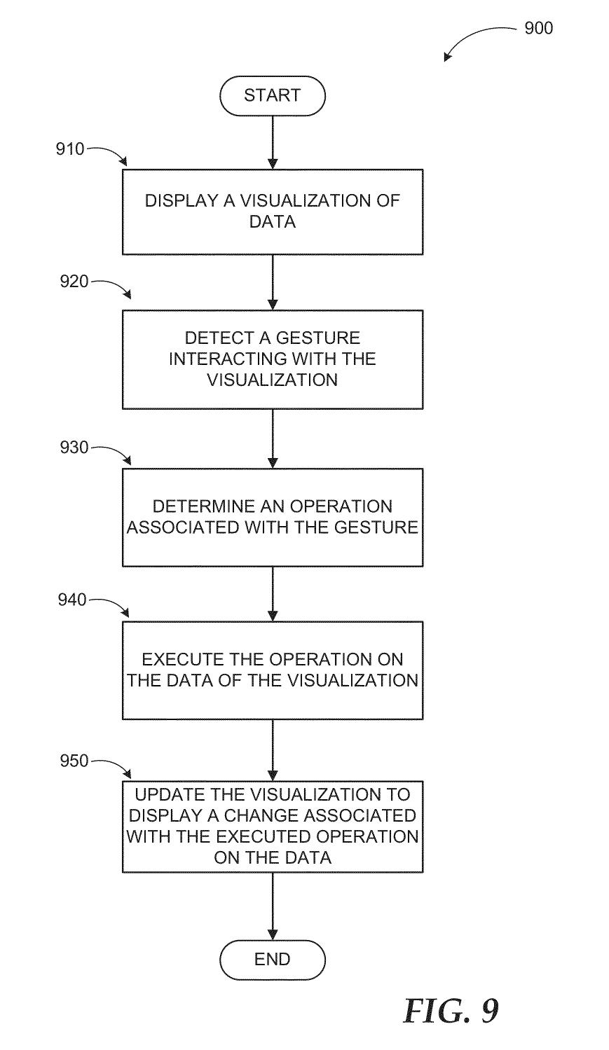

FIG. 9 illustrates a logic flow diagram for a process automatically manipulating visualized data based on interactivity according to embodiments. Process 900 may be implemented by a data visualization application, in some examples.

Process 900 may begin with operation 910 where the data visualization application may display a visualization of data. The visualization may be a graph, a chart, and comparable ones of the data. At operation 920, a gesture may be detected in interaction with the visualization. The gesture may include a variety of input types including touch, keyboard, pen, mouse, visual, audio, eye tracking, and comparable ones. Next, the application may determine an operation associated with the gesture at operation 930. The gesture may be matched to a reduction, expansion, zoom in, zoom out, merge, split, or style change operation.

The data visualization application may execute the operation on the data of the visualization at operation 940. The data may be changed in response to the execution. The visualization may be updated to display a change associated with the executed operation on the data at operation 950.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 900 are for illustration purposes. Automatically manipulating visualized data based on interactivity, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for automatically manipulating visualized data based on interactivity, the method comprising:
displaying a visualization;
detecting a gesture on the visualization;
determining an operation associated with the gesture;
executing the operation on the data of the visualization; and
updating the visualization to display a change associated with the executed operation on the data.

2. The method of claim 1, wherein determining the operation associated with the gesture comprises:
matching one of: an expansion, a reduction, a merge, a split, a zoom in, a zoom out, and a style change to the gesture.

3. The method of claim 1, further comprising:
interpreting the gesture as a pinch action; and
matching the pinch action to a reduction operation.

4. The method of claim 3, further comprising:
executing the reduction operation by:
computing a ratio based on an end length of the pinch action and a start length of the pinch action;
reducing a number of displayed data elements of the visualization based on the ratio; and
updating the visualization to reflect a reduction in the number of the displayed data elements.

5. The method of claim 1, further comprising:
interpreting the gesture as a spread action; and
matching the spread action to an expansion operation.

6. The method of claim 5, further comprising:
executing the expansion operation by:
computing a ratio based on an end length of the spread action and a start length of the spread action;
expanding a number of displayed data elements of the visualization based on the ratio; and
updating the visualization to reflect an expansion in the number of the displayed data elements.

7. The method of claim 1, further comprising:
using a speed of the gesture to determine one of: a reduction operation and an expansion operation to be applied to a number of displayed data elements proportionally to the speed, in response to matching the gesture to one of: the reduction operation and the expansion operation.

8. The method of claim 1, further comprising:
matching the gesture to a zoom in operation, on a displayed data element of the visualization.

9. The method of claim 8, further comprising:
executing the zoom in operation by:
retrieving a range of data elements within predetermined outer boundaries centered on the displayed data element;
marking the range of data elements for display in the visualization; and
updating the visualization to display the range of data elements.

10. The method of claim 1, further comprising:
detecting the gesture outside the visualization; and
matching the gesture to a zoom out operation.

11. The method of claim 10, further comprising:
executing the zoom out operation by:
determining a range of data elements that includes displayed data elements of the visualization based on outer boundaries of the range;
centering the outer boundaries on one of the displayed data elements adjacent to a location of the gesture; and
updating the visualization to display the range.

12. A computing device for automatically manipulating visualized data based on interactivity, the computing device comprising:
a memory configured to store instructions; and
a processor coupled to the memory, the processor executing a data visualization application in conjunction with the instructions stored in the memory, wherein the application is configured to:
display a visualization;
detect a first gesture on the visualization;
match an operation including one of: an expansion, a reduction, a merge, a split, a zoom in, a zoom out, and a style change to the first gesture;
execute the operation on the data of the visualization; and
update the visualization to display a change associated with the executed operation on the data.

13. The computing device of claim 12, wherein the application is further configured to:
detect a second gesture on another visualization concurrently to the first gesture;
interpret the first gesture and the second gesture to converge; and
match the first gesture and the second gesture to a merge operation.

14. The computing device of claim 13, wherein the application is further configured to:
execute the merge operation through:
match data elements of the visualization and the other visualization;
apply an equation including at least one of: an addition, a multiplication, a subtraction, a division, and a custom equation to the matched data elements of the other visualization and the visualization to generate merged data; and
display a merged visualization of the merged data.

15. The computing device of claim 12, wherein the application is further configured to:
match the first gesture to a style change operation based on a location of the first gesture and a type of the first gesture.

16. The computing device of claim 15, wherein the application is further configured to:
redraw the visualization and elements of the visualization based on alternate visualization attributes of the data; and
alter at least one of: a visualization type and at least one attribute of the elements including: a color, a shading, a depth, a shape, and a highlighting.

17. A computer-readable memory device with instructions stored thereon for automatically manipulating visualized data based on interactivity, the instructions comprising:
displaying a visualization;
detecting a gesture on the visualization;
matching an operation including one of: an expansion, a reduction, a merge, a split, a zoom in, a zoom out, and a style change to the gesture;
prompting for a user input to determine the operation in response to an inability to automatically determine the operation;
executing the operation on the data of the visualization; and
updating the visualization to display a change associated with the executed operation on the data while automatically selecting a type and a style of the visualization based on the change.

18. The computer-readable memory device of claim 17, wherein the instructions further comprise:
automatically suggesting a plurality of operation options based on a history of prior operations used for related gestures.

19. The computer-readable memory device of claim 18, wherein the instructions further comprise:
presenting the plurality of operation options as actionable text descriptions of potential updates to the visualization.

20. The computer-readable memory device of claim 18, wherein the instructions further comprise:
presenting the plurality of operation options as actionable graphic representations of potential updates to the visualization.
